(19) United States
(12) Patent Application Publication
(10) Pub. No.: US 2019/0020191 A1
(43) Pub. Date: Jan. 17, 2019

(54) PREVENTION SYSTEM AND PROCESS AGAINST ELECTRIC SHOCKS AND/OR ELECTRIC ARCS

(71) Applicants: JUAN CHARNECO FERNÁNDEZ, SEVILLA (ES); RICARDO PALACIOS DE LA OLLA, Sevilla (ES); CONSEJO SUPERIOR DE INVESTIGACIONES CIENTIFICAS, MADRID (ES)

(72) Inventors: JUAN CHARNECO FERNÁNDEZ, SEVILLA (ES); RICARDO PALACIOS DE LA OLLA, SEVILLA (ES); MANUEL DELGADO RESTITUTO, SEVILLA (ES)

(21) Appl. No.: 15/762,823

(22) PCT Filed: Sep. 23, 2016
(86) PCT No.: PCT/ES2016/070668

§ 371 Date: Aug. 21, 2018

(30) Foreign Application Priority Data
Sep. 24, 2015 (ES) P201531367

(51) Int. Cl. H02H 5/12; G08B 21/02; G08B 21/18

(52) U.S. Cl. CPC H02H 5/12; G08B 21/18; G08B 21/02

(57) ABSTRACT

The purpose of this invention refers to a system and method of prevention against electrical discharges and/or electric arcs on individuals standing nearby an electrical installation (20). Specifically, this system comprises an actuator device (200, 200′), capable of interrupting the electrical flow of said electrical installation (20) and which is connected wirelessly with a sensor device (100) capable of wirelessly detecting electric fields emitted by the individual's body of the individual and/or by the electrical installation (20), additionally capable of indicating to the individual that the latter is at risk of suffering an electric shock and/or an electric arc.

### OBJECT OF THE INVENTION

The object of this invention relates to a prevention system and method against electric shocks and/or electric arcs to individuals who are close to an electrical installation.

This invention is based on the study of the behaviour of the electric fields surrounding a system.

More specifically, this invention detects the risk of electric shock or electric arc, and interrupts the electrical flow in an installation, whether low-voltage or high-voltage, before said risk materialises. Moreover, this invention may warn individuals about the existence of a risk of electric shock and/or electric arc.

### BACKGROUND OF THE INVENTION

Currently, various prevention systems against electric shocks and/or electric arcs are known.

One example of an electrical protection system is disclosed in the Spanish invention patent with publication number ES2029416A6. Specifically, this document describes an electronic equipment designed for the safety, electrical protection and optimisation of a power connection. Said equipment basically comprises electronic measuring, comparator and actuator circuits.

By means of these circuits, the equipment is capable of preventing sparks and explosions when a short-circuit occurs at an electrical installation, as well as autodisconnecting the load connected to the electrical installation as a result of the short-circuit, without activating the magneto-thermal breaker installed the electrical installation.

Moreover, this equipment audibly warns individuals when it detects a short-circuit or an overload in the electrical installation.

Although this document describes how to detect a short-circuit and an electrical overload, it does not prevent individuals from receiving a shock or an electric arc.

Another example of an electrical detection device is that disclosed by Spanish patent ES2259421T3. More specifically, this document describes a device designed to determine the absence, or the presence, of voltage in a single-phase or poly-phase power line with external insulation. This device is primarily designed to be used in high-voltage lines. especially those that have wire connections with voltages of the order of 1000V. Moreover, this device is equipped with a casing that contains a meter and an electronic analyser, as well as a detector head that comprises at least three measuring electrodes connected to the meter and the electronic analyser. Thus, the meter and the electronic analyser make it possible to analyse the signals received from the measuring electrodes when the latter are pressed against the external insulation of the power line.

This device may only be used when it is placed on high-voltage lines, and for a very specific use: detection of voltage in a power line. Therefore, this device only notifies of the presence or absence of electrical voltage in a power line with external insulation, but does not avoid or prevent electric shocks or arcs to individuals who are close-by or checking the power line.

On the other hand, differential automatic breakers may also be considered as background of the invention, since they interrupt the electrical flow when a person suffers an electric shock. More specifically, these differential automatic breakers are installed in every electrical installation, specifically in the corresponding electrical switchgear.

Currently, the efficiency of differential automatic breakers is very questionable, since, in order to interrupt the electrical flow, it is necessary for an individual to come into contact with the ground and a mass subjected to an electrical voltage. I.e. it requires that an electric current circulate through the individual's body towards the ground.

Moreover, these differential automatic breakers only protect individuals against contacts between a phase conductor and a grounded conductor in the electrical installation, but are completely inoperative when individuals come into direct contact with a phase conductor and a neutral conductor, or with two phase conductors.

It is worth mentioning that said phase-to-ground and phase-to-phase electrical contacts are very frequent and dangerous. This is due to the fact that, if there is no current towards the ground, the differential automatic breaker considers the individual's body to be a simple electrical receiver with an approximate resistance ranging between 1,500 and 2,000 ohms, and, therefore, does not automatically cut off the electrical flow in the electrical installation.

One example of this problem is that, in the case of electric shock due to direct contact with a phase conductor and a neutral conductor, an approximate current of 0.11 Amperes (230V/2000 Ohms=0.11 Amperes) circulates through the individual's body. Said amount of amperes may cause the death of a person, who cannot be saved by the differential automatic breaker, even if the latter has a sensitivity of 0.03 Amperes.

### DESCRIPTION OF THE INVENTION

This invention relates to a method system for detecting and preventing electric shocks and/or arcs to individuals who are close to an electrical installation.

The protection against electric shocks offered by this invention is based on the results of tests and measurements performed on the bodies of over 100 individuals, with different morphologies, sexes and ages, when they were in physical contact with an electrically active element, having used these results to develop a system capable of detecting the risk of electric shock before it occurs.

The results show that the body of any individual who is physically connected to an electrically active element is electrically charged and emits an electric field capable of being wirelessly detected by the system of the invention, even when no electric current flows through it.

More specifically, when an individual's body comes into physical contact with an electrically active element without external insulation that is subjected to an electric potential higher than 25 V, the body emits an electric field capable of being detected by this invention.

Moreover, when an individual's body comes into physical contact with an electrically active element with external insulation that is subjected to an electric potential higher than 100 V. the body emits an electric field capable of being detected by this invention.

In regard to the protection against electric arcs, the system of the invention is based on the results of a comparative analysis of the magnitudes of the existing electric fields to which individuals are exposed and their risk of sustaining an electric arc.

As a reference, the limit values for electric fields specified in Resolution 295/2003 of the Ministry of Labour, Employment and Social Security, on “technical specifications for ergonomics and manual handling of loads, and radiation”, were used.

More specifically, the system warns individuals when the distance between their body and the elements subjected to high voltages indicates that they are exposed to electric field magnitudes equal to or higher than 15 kV/m.

Optionally, the system allows the users to set said warning to between 5 kV/m and 15 kV/m.

Moreover, the system uses a specific alert to warn individuals when they are exposed to electric field magnitudes equal to or higher than 20 kV/m, which indicates that they are at a shorter distance than that allowed and that, moreover, if this distance is reduced by a percentage that entails an imminent risk of an electric arc, the electrical flow interrupter system will be activated.

It is worth noting that the system of the invention allows for the programming of new reference values, equivalent to the new limit values for electric fields established in modified regulations.

For complete protection, this system is capable of interrupting the power supply under low-voltage and high-voltage conditions whenever it determines that an individual faces an imminent risk of an electric shock and/or an electric arc.

This system comprises at least one actuator device capable of interrupting the electrical flow in the electrical installation and at least one sensor device capable of wirelessly detecting electric near-fields that is wirelessly connected to the actuator device.

More specifically, an actuator device may be connected to a plurality of sensor devices. These sensor devices may be located in the area of the electrical installation and/or can be worn by individuals.

Moreover, in areas with a plurality of different electrical installations, a plurality of sensor devices connected to at least one actuator device may be used.

More specifically, the electric near-field sensor device comprises:
at least one electric field detector antenna,
at least one amplifier circuit connected to the detector antenna,
at least one low-pass fitter circuit connected to the amplifier circuit,
one comparator circuit connected to the low-pass filter circuit,
one control and command circuit connected to the comparator circuit and the amplifier circuit,
one communication circuit connected to the comparator circuit, which is capable of sending a control signal to the actuator device,
at least one power supply that supplies power to these circuits, and
one enveloping insulating housing that includes at least these circuits.

Moreover, this sensor device comprises:
an alarm circuit, connected to the comparator circuit and the control and command circuit, and
a circuit that generates electromagnetic waves with frequencies ranging between 50 Hz and 60 Hz, with an antenna that emits electromagnetic waves, connected to the control and command circuit.

More specifically,
the detector antenna is integrated into at least one of the outer or inner sides of the enveloping housing. Moreover, one of the outer sides of this enveloping housing is equipped with fastening means that make it possible to attach it to an individual's body or clothing, and/or even to a solid structure, such as the wall or the ceiling of a room, a table or other furniture.

Optionally, the detector antenna has incorporated means for expanding the detection area of the antenna by means of an electrical conductor element in any physical form.
Amplifier circuit comprises a pre-amplifier, connected to the detector antenna, and a controllable-gain amplifier, connected to the pre-amplifier, the low-pass filter circuit and the control and command circuit.
Moreover, the low-pass filter circuit comprises a low-pass filter that allows for the passage of electrical signals between 10 Hz and 100 Hz.
Specifically, the comparator circuit comprises a first comparator circuit, connected to the control and command circuit and the communication circuit, and a second comparator circuit, connected to the control and command circuit and the alarm circuit.
The control and command circuit comprises at least one control stage associated with a command interface that makes it possible to modify at least one of the control parameters previously programmed in the control stage.
Moreover, the communication circuit comprises a radio transmitter which, upon being activated, transmits wireless radio signals that are communicated to the actuator device, and a transmission interface which is capable of adjusting the radio transmitter.
The alarm circuit comprises an output stage, which is connected to the control and command circuit and at least one of the following indicator elements:
   an acoustic indicator,
   an optical indicator, or
   a vibrating indicator.

Thus, the alarm circuit warns individuals when there is a risk of electric shock and/or electric arc. It is worth mentioning that the detector device may be used in an autonomous manner for all the alert functions, even when the actuator device is not operative. Finally, by means of the wave emitter antenna, the generator circuit generates a plurality of electric waves that make it possible to verify the correct detection of electric fields by the detector antenna.

Alternatively, the communication circuit of the sensor device comprises a circuit that generates and increases the amplitude of interrupter radio pulses, which is activated by means of the first comparator circuit and is connected to an emitter electrode. This configuration makes it possible to generate an interrupter radio pulse that is capacitively transmitted from the emitter electrode to the device through an individual's body and the electricity grid.

Thus, when individuals come into physical contact with an electrically active element, they transmit said interrupter radio pulse from their body to the actuator device, using the electrically active element with which they comes into contact.

It is worth mentioning that the pulse is performed for a very short time, of the order of milliseconds; i.e. the time between the moment when an individual comes into contact with the electrically active element and the moment when the actuator device disconnects the electrical installation.

Thus, the radio pulse would be the same in all the sensor devices and all the actuator devices would respond to it by interrupting the electrical flow.

Optionally, in addition to the elements previously described, the sensor device comprises:
an additional detector antenna,
an additional pre-amplifier connected to said additional antenna,
an additional variable-gain amplifier connected to said additional pre-amplifier, and
an additional low-pass filter connected to said additional amplifier.

More specifically, one of the detector antennae is integrated into one of the outer sides of the enveloping housing, whereas the other detector antenna is integrated into one of the inner sides of the enveloping housing. Moreover, each detector antenna is connected to its respective pre-amplifier, which is connected to its variable-gain amplifier and, in turn, the latter is connected to its low pass fitter. Both low-pass filters are connected to the comparator circuit.

Thanks to this configuration, when connects the sensor device to the individuals or their clothing. The detector antenna on the outer side faces the electrically active elements and, therefore, detects the electric fields emitted by these elements to which the individuals are exposed, whereas the inner detector antenna detects the electric fields emitted by the individuals' bodies when they are in physical contact with an electrically active element.

Thus, when the sensor device detects an increase in the existing electric field around it, it warns individuals by means of the alarm circuit and/or transmits wireless radio signals, by means of the communication circuit, which are communicated to the actuator device in order to interrupt the electrical flow in the electrical installation.

On the other hand, the actuator device comprises:
a radio signal receiver circuit, capable of receiving the wireless radio signals sent by the communication circuit,
a receiver interface capable of adjusting the receiver,
a coupling unit between the actuator device and the electrical installation,
a switch-off circuit capable of being connected to the electrical installation,
a safety circuit designed to verify the correct operation of the actuator device,
an enveloping insulating housing that includes at least both circuits, and
a power supply designed to supply all the circuits.

In one embodiment of the actuator device, it may be inserted into the switchgear of the electrical installation, this being considered to be the actuator device with a permanent configuration.

Thus, the coupling unit of the actuator device is located on one of the outer sides of the enveloping housing, which can be connected to the DIN rail of an electrical panel of the switchgear of the electrical installation or an independent electrical panel, Moreover, this body comprises at least one electrical input and one electrical output capable of being connected to the wiring of said low- or high-voltage electrical switchgear, such that it may cut off the electrical flow.

The switch-off circuit of the actuator device with a permanent configuration comprises a contactor block essentially formed by an interrupter contactor, equipped with contacts capable of being connected to the electrical installation in order to interrupt the electrical flow when the contacts are separated from one another, and a power circuit connected to the contactor block that separates or connects the contacts.

Alternatively, the switch-off circuit for a high-voltage installation comprises at least one electrical input and one electrical output capable of being connected to the turn-off switchgear of the high-voltage electrical installation itself.

At the same time, the safety circuit of the actuator device with a permanent configuration comprises a power interface connected to the power circuit, which makes it possible to check the operation of the contactor block, reset the power circuit, reset and select the type of reset.

In another embodiment of the actuator device, it may be inserted into the electrical installation by being connected to an existing AC power outlet in the electrical installation, this being considered to be the actuator device with a temporary configuration. Thus, the coupling unit is located on one of the outer sides of the enveloping housing and comprises a male power supply plug capable of being inserted into an AC power outlet of the electrical installation.

More specifically, the switch-off circuit of the actuator device with a temporary configuration comprises an electronic circuit capable of causing a ground fault of the electrical flow in the electrical installation and a controlled overcurrent of the same flow in the electrical installation, such that at least one compulsory differential automatic and/or magneto-thermal breaker of said installation will be triggered and interrupt the electrical flow.

Moreover, the actuator device, with either a permanent or temporary configuration, comprises an interrupter radio pulse receiver connected to the switch-off circuit and, therefore, capable of being connected to the electrical installation. This receiver can recognise the radio pulse sent from the sensor device and activate the switch-off circuit of the actuator device, such that it may interrupt the flow in the electrical installation.

The prevention method against electric shocks and/or electric arcs to individuals who are close to an electrical installation used by the system described above comprises the following steps:
positioning at least one actuator device in the electrical installation.
positioning at least one sensor device.
selecting, by means of a command interface included in the sensor device, a mode of use for the sensor device,
detecting, by means of a detector antenna included in the sensor device, an electric near-field,
amplifying the signal of the electric near-field by means of an amplifier circuit,
comparing, by means of a comparator circuit, said signal of the electric field with the alert and/or communication threshold values included in a control and command circuit,
sending, by means of a communication circuit, a radio signal to the actuator device, such that it may prevent electrical flow in the electrical installation when any of the communication threshold values are exceeded, and
sending, by means of an alarm circuit, an acoustic, visual or vibrating signal to the individuals who are close to the installation when any of the alert threshold values are exceeded.

Thus, depending on the positioning of the actuator device, the positioning of the sensor device and the type of electrical installation, i.e. whether the installation is low-voltage or high-voltage, individuals select a mode of use.

Each mode of use has an alert and a communication threshold value included in the control and command circuit. Thus, when the communication threshold value is reached, the sensor device sends, by means of the communication circuit, a radio signal to the actuator device, such that may interrupt the electrical flow in the electrical installation. Whereas, when the alert threshold value is reached, the sensor device warns, by means of an alarm circuit, which comprises an acoustic, visual or vibrating indicator. The individuals who are approaching the electrically active elements, or the individuals who are attempting to identify which elements close-by are electrically active.

Thus, this invention prevents against electric shock and electric arc by detecting electric fields; specifically, it makes it possible to detect the risk of electric shock when an individual comes Into physical contact with an electrically active element, with or without insulation, regardless of the type of electrical contact.

Moreover, this invention also makes it possible to detect the risk of an electric arc when individuals approach elements subjected to high voltages, regardless of the magnitude of said high voltage.

In other words, this invention makes it possible to detect the electric field emitted by individuals' bodies when they come into contact with an electrically active element, as well as the electric field emitted by the electrically active element itself.

Therefore, this system makes it possible to prevent electric shocks even before they occur, as well as electric arcs, also before they occur.

It is worth mentioning that the systems known thus far only detect shocks when a connection is established, through an individual's body, between a single-phase conductor and a grounded conductor in the electrical installation, without taking into account that, currently, connections between a single-phase conductor and a neutral conductor, or between two single-phase conductors, are more frequent, due to the insulating footwear being worn. Thus, this invention protects against phase-to-phase, phase-to-neutral and phase-to-ground contacts, and may interrupt the electrical flow for any type of connection, thereby improving the reliability of the system with respect to the prior art.

This system makes it possible to interrupt the electrical flow in any electrical installation when there is contact between an individual and a non-insulated electrically active conductor and/or there is imminent risk of an electric arc, before any current circulates through the individual's body. Moreover, it warns individuals who have come into contact with an insulated electrically active conductor, or warns them that they are very close to an area of the electrical installation with a risk of an electric arc.

Optionally, in low-voltage installations, the antenna of the radio receiver of the actuator device is connected by means of an impedance adapter that adjusts the impedance of the radio circuit to the impedance of the wiring of the electrical installation wherein the actuator device is located, in order to improve communications between the communication circuit of the sensor device and the radio receiver of the actuator device, and, therefore, expand the coverage when necessary, as in large-sized low-voltage installations.

Preferably, the power supply for the sensor device is a commercially accessible battery, which may or may not be rechargeable.

Another advantage of this invention is that it makes it possible to connect a plurality of sensor devices that may be simultaneously used by one or several individuals to a single actuator device.

Finally, this system also makes it possible to detect, at a distance of at least 4 metres, at least one individual who comes into physical contact with a non-insulated electrically active element. Thus, when there are several individuals in the same area, they would all be protected by a single system, i.e. a sensor device and an actuator device, without the need for any additional elements.

### DESCRIPTION OF THE DRAWINGS

In order to supplement the description being made, and to contribute to a better understanding of the characteristics of the invention, according to a preferred embodiment thereof, a set of drawings is attached to said description as an integral part thereof. where the following is represented for illustrative, non-limiting purposes:

FIG. 1.—Shows a schematic view of the electric field sensor device.

FIG. 2.—Shows a schematic view of an embodiment of the actuator device with a permanent configuration.

FIG. 3.—Shows a schematic view of an embodiment of the actuator device with a temporary configuration.

FIG. 4a.—Shows a schematic view of the positioning of the sensor device on the wall of a room and its corresponding coverage area.

FIG. 4b.—Shows a schematic view of the positioning of the sensor device on the ceiling of a room and its corresponding coverage area.

FIG. 4c.—Shows a schematic view of the positioning of the sensor device on the wall of a room and a metallic conductor connected to the detector antenna (1), which is designed to expand the coverage thereof and, specifically, extends to the point reached by said metallic conductor element.

FIG. 5a.—Shows a schematic view of the positioning of the sensor device on a belt.

FIG. 5b.—Shows a schematic view of the positioning of the sensor device outside a pocket.

FIG. 5c.—Shows a schematic view of the positioning of the sensor device inside a pocket.

FIG. 5d.—Shows a schematic view of the positioning of the sensor device on the rear part of a safety helmet.

FIG. 5e.—Shows a schematic view of the positioning of the sensor device on the front of a safety helmet.

FIG. 5f—Shows a schematic view of the positioning of the sensor device on the rear part of a hat.

FIG. 5g.—Shows a schematic view of the positioning of the sensor device on the front part of a hat.

FIG. 6.—Shows a schematic view of the positioning of the sensor device on an individual's arm.

FIG. 7.—Shows an embodiment of the actuator device with a permanent configuration.

FIG. 8.—Shows an embodiment of the actuator device with a permanent configuration installed in an electrical panel.

FIG. 9.—Shows an embodiment of the actuator device with a temporary configuration.

### PREFERRED EMBODIMENT OF THE INVENTION

In a preferred embodiment of the invention, the system for preventing electric shocks and/or electric arcs to individuals who are close to an electrical installation (20) is formed by a sensor device (100) and an actuator device (200, 200′) that controls the electrical flow in the electrical installation (20). Both devices comprise an enveloping insulating housing that contains the rest of the elements that make it up.

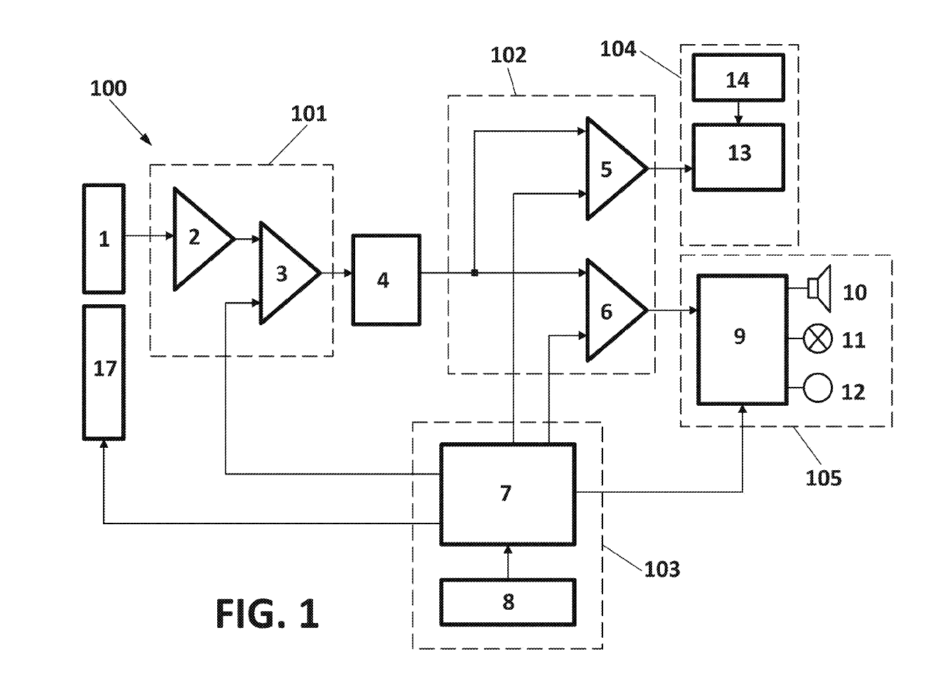

More specifically, as schematically shown in FIG. 1, the sensor device (100) comprises the following in an enveloping housing:
an electric near-field detector antenna (1) that is integrated into one of the outer sides of the enveloping housing that makes up the sensor device (100).
a control and command circuit (103) that comprises a control stage (7) connected to a command interface (8), with which individuals may select and programme the sensor device (100).
an amplifier circuit (101) connected to the detector antenna (1) and the control and command circuit (103), composed of a pre-amplifier (2), which amplifies the electrical signals originating from the detector antenna (1), and a controllable-gain amplifier (3), which amplifies the electrical signals originating from the pre-amplifier (2) with a gain determined by the control stage (7).
a low-pass filter circuit (4) composed of a low-pass filter located at the output of the controllable-gain amplifier (3) of the amplifier circuit (101), which only allows for the passage of electrical signals with a frequency ranging between 10 Hz and 100 Hz.
a comparator circuit (102) connected to the output of the low-pass filter, composed by a first comparator circuit (5) connected to a communication circuit (104), a second comparator circuit (6) connected to an alarm circuit (105), both comparators (5, 6) being connected to the control and command circuit (103).
a communication circuit (104) that is activated by means of the first comparator circuit (5) when the communication threshold level included in the control stage (7) is exceeded, which comprises a radio transmitter (13) designed to transmit specific wireless radio signals and a transmission interface (14) that makes it possible for individuals to adjust the radio transmitter (13).
an alarm circuit (105) connected to the comparator circuit (102) and the control and command circuit (103), designed to warn individuals about the risk of electric shock and/or electric arc, Specifically, the alarm circuit (105) comprises an output stage (9) that activates an acoustic indicator (10), an optical indicator (11) and/or a vibrating indicator (12) when the second comparator circuit (6) exceeds the alert threshold level included in said control stage (7).
a circuit that generates electromagnetic waves (17) with frequencies ranging between 50 Hz and 60 Hz, connected to the control and command circuit (103), and comprises an incorporated emitter antenna, which operates with sequential emission levels stored in the control stage (7), in order to verify the correct detection of electric fields by the detector antenna (1) and, consequently, also verify the correct operation of the entire system.

More specifically, the detector antenna (1) is capable of:
detecting the electric field emitted by the body of an individual to which the sensor device (100) is adapted;
detecting, at a distance of at least 4 metres, the electric field emitted by the body of at least the individual who is included within said range;
detecting the existing electric field in the elements subjected to high voltages to which at least the individual is exposed; and
detecting the existing electric field in the elements subjected to low voltages that face the detector antenna (1) itself.

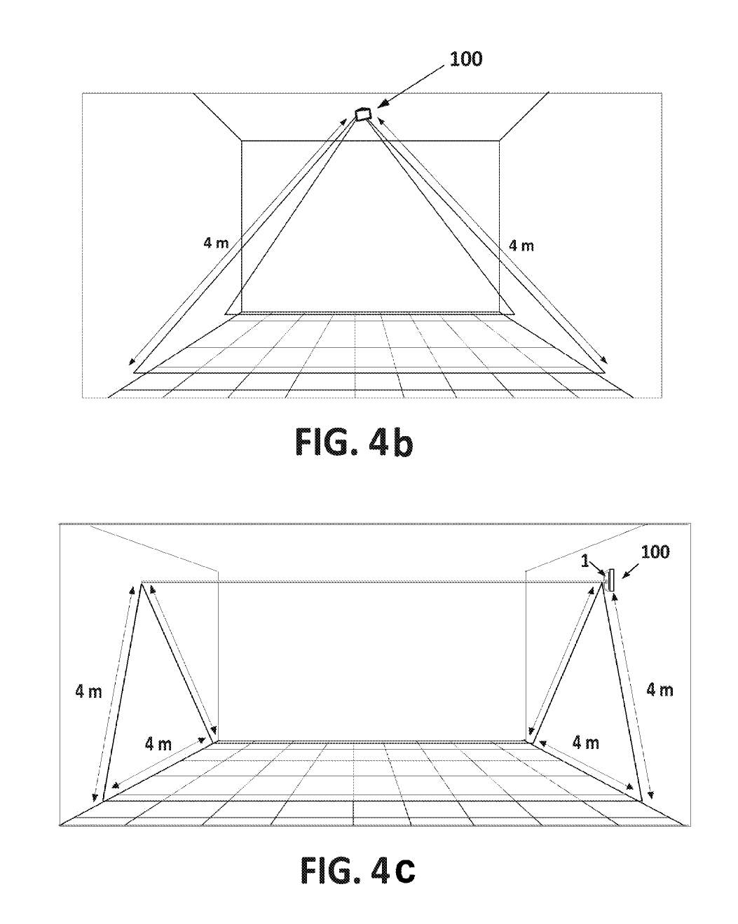

It is worth noting that the detector antenna (1) is capable of detecting, at a distance of at least 4 metres, the electric field emitted by the body of at least the individual included within said range, when the sensor device (100) is adapted to a ceiling, wall, work table or similar, as shown in FIGS. 4a, 4b and 4c.

More specifically, FIG. 4c represents the operation of the sensor device adapted to the wall of a room and a metallic conductor element connected to the detector antenna (1), which is designed to expand the coverage thereof and, specifically, extends to the point reached by said metallic conductor element.

The control stage (7) controls the gain values of the controllable-gain amplifier (3), the communication threshold that activates the output of the first comparator circuit (5), the alert threshold that activates the output of the second comparator circuit (6), the condition of the acoustic indicator (10). the optical indicator (11) or the vibrating indicator (12), and the generator circuit (17).

Moreover, the control stage (7) includes the communication and alert threshold levels that activate the output of the first and the second comparator circuits (5, 6) for low and high voltages.

More specifically, the alert and/or communication threshold values are dependent upon at least the type of electrical installation (20), i.e. whether the installation is low-voltage or high-voltage.

In the case of low-voltage installations, the first comparator (5) activates its output and, therefore, activates the radio transmitter (13) when it detects an electric field equivalent to the electric field emitted by the body of an individual who comes into physical contact with a non-insulated element subjected to an electrical voltage greater than 50 V.

On the other hand, the second comparator (6) activates its output and, therefore, one of the indicators (10, 11, 12) through the output stage (9) when it detects an electric field equivalent to the electric field emitted by the body of an individual when it is in physical contact with a non-insulated element and subjected to an electrical voltage ranging between 25 V and 50 V.

Moreover, the second comparator (6) also activates its output when it detects the electric field emitted by the body of an individual who is in physical contact with an insulated element subjected to an electrical voltage of at least 100 V.

It is worth mentioning that, in this preferred embodiment, the sensor device (100) was used to measure the electric field emitted by a variety of individuals when they were subjected to a range of different voltages, but without any current circulating, in order to establish the alert and communication threshold values for low-voltage electrical installations.

In the case of high-voltage installations, the first comparator (5) activates its output and, therefore, activates the radio transmitter (13) when it detects an electric field emitted by an electrically active element greater than 20 kV/m by a percentage that entails an imminent risk of an electric arc.

On the other hand, the second comparator (6) activates its output and, therefore, one of the indicators (10, 11, 12) through the output stage (9) when it detects an electric field of at least 5 kV/m emitted by an electrically active element.

Optionally, the second comparator (6) also activates its output and, therefore, one of the indicators (10, 11, 12) through the output stage (9) when it detects an electric field emitted by an electrically active element that exceeds the one selected by an individual on the interface (8). Specifically, this electric field is between the preferred safety limits of 5 kV/m and 15 kV/m.

Moreover, the second comparator (6) also activates its output when it detects an electric field emitted by an electrically active element with a value close to 20 kV/m. In this case, since there is a high risk of an electric arc, the output stage (9) activates, at the command of the control stage (7), all the indicators (10, 11, 12), which remain activated until the user moves away from the electrically active conductor.

Moreover, individuals may select and programme the following through the command interface (8):
the mode of use under low-voltage or high-voltage conditions. i.e. the type of electrical installation (20) wherein the system is used,
the maximum gain value for the controllable-gain amplifier (3), in order to use the sensor device (100) in the normal-sensitivity mode or the high-sensitivity mode,
a variable threshold level from which the alarm circuit (105) will become activated within pre-established limits,
the condition of the acoustic indicator (10), the optical indicator (11) or the vibrating indicator (12), and
the activation of the circuit (17) that generates electromagnetic waves with an incorporated emitter antenna designed to verify the correct operation of the system.

More specifically, the sensor device (100) presents the following operating modes: low-voltage normal-sensitivity mode, low-voltage high-sensitivity mode and high-voltage mode. Consequently, one of the low-voltage modes is selected when individuals are close to, or about to work in, a low-voltage electrical installation, and the high-voltage mode is selected when individuals are close to, or about to work in, a high-voltage electrical installation.

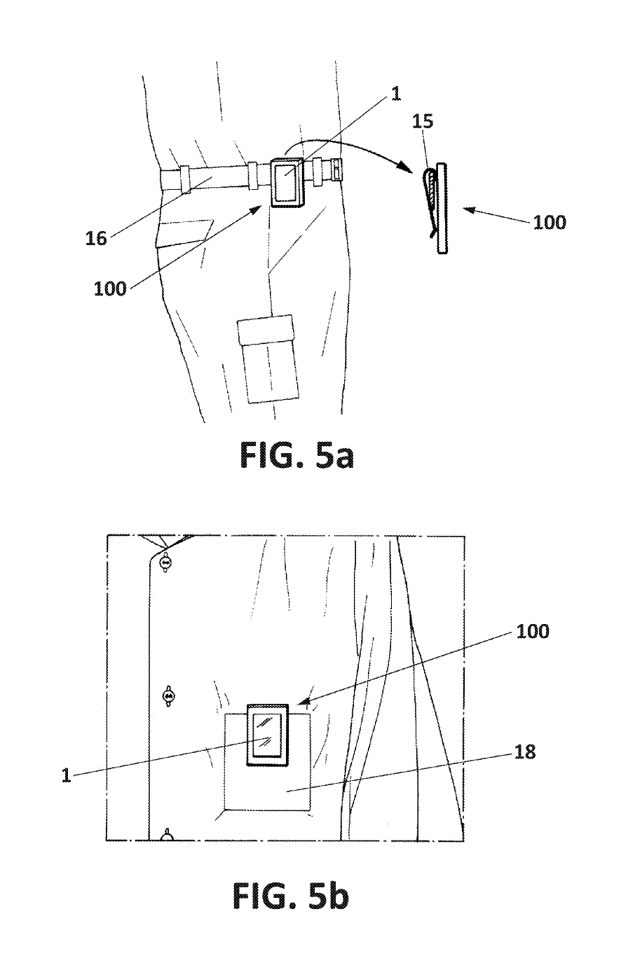

The low-voltage normal-sensitivity mode is used when individuals have the sensor device (100) connected to their clothing through fastening means, such as a clip (15), inserted into one of the outer sides of the enveloping housing, as shown in FIGS. 5a and 5b, specifically a shirt pocket (28) or a belt (16). Moreover, as may observed in FIG. 5c, the sensor device (100) may be inside a trouser pocket (29).

Moreover, as may be observed in FIGS. 5d and 5e, the sensor device (100) may be positioned on a safety helmet, since the fastening means comprise an integrable male part on the casing of the enveloping housing of the sensor device (100) that fits together with an integrable female part included in a safety helmet. Alternatively, this integrable male part may fit into a safety hat or hood.

Furthermore, as may be observed in FIGS. 5f and 5g, the sensor device (100) may be positioned on a hat, since the fastening means comprise at least double-sided adhesive tape, Velcro adhesive tape or fastener clips that may be attached to the hat. Alternatively, they may be attached to the individuals' clothing, accessories or helmets.

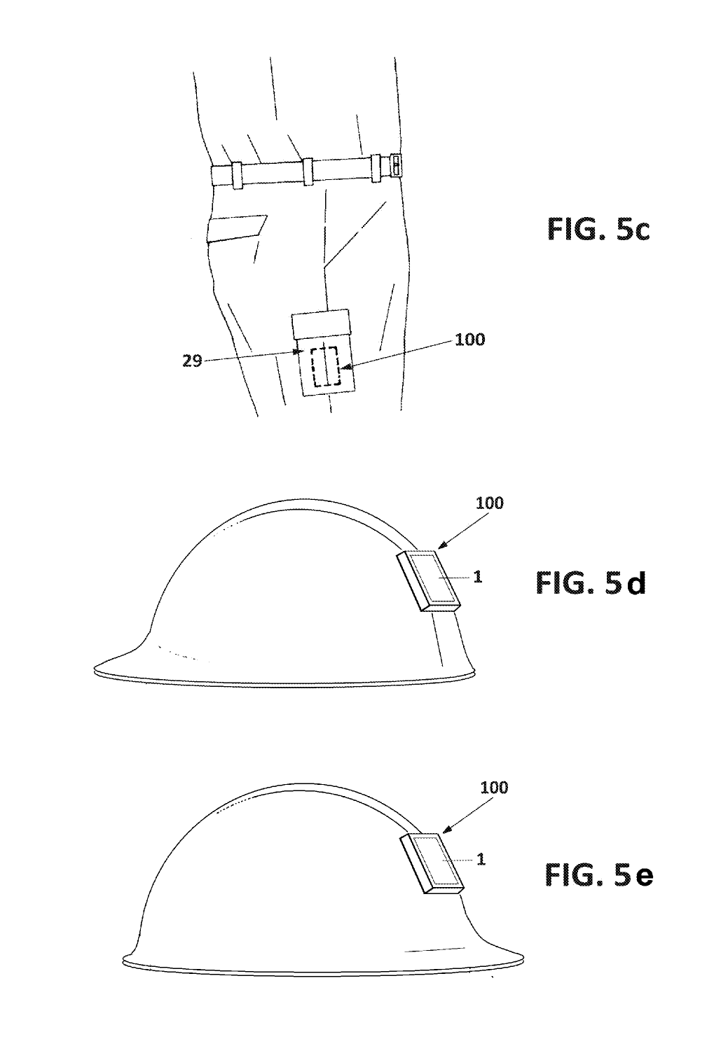

Alternatively, the detector (100) may also be attached to an extremity of an individual's body by means of an elastic band (32), as shown in FIG. 6.

Thus, when the low-voltage normal-sensitivity mode is selected, the sensor device (100) detects when an individual is in physical contact with an insulated or non-insulated electrically active element.

Moreover, in the low-voltage normal-sensitivity mode, individuals may place the sensor device (100) facing any element connected to a low-voltage grid, in order to determine whether this specific element is electrically active.

The low-voltage high-sensitivity mode Is used when the sensor device (100) is positioned through other fastening means, such as openings capable of receiving screws for coupling to the wall or the ceiling of a room, as shown in FIGS. 4a and 4b. Thus, when an individual is within the range of detection of the sensor device (100), which may exceed a 4 m radius, the sensor device (100) detects, and recognises, when the individual is in physical contact with an insulated or non-insulated electrically active element.

More specifically, under low-voltage conditions, in both the high-sensitivity and low-sensitivity modes, the sensor device (100) may detect that an individual is undergoing electrical contact by comparing the electric field emitted by the individual's body, which Is detected by means of said detector antenna (1), with communication threshold values programmed in the control stage (7). Moreover, it may detect that an individual is at risk of undergoing electrical contact when the alert threshold values are exceeded.

More specifically, in the low-voltage mode, in order to optimise communications by the communication circuit (104) of the sensor device (100) and the radio receiver (23) of the actuator device (200, 200′), the radio receiver circuit (23) comprises an impedance adapter that connects the radio circuit (23) to the wiring of the low-voltage electrical installation (20), adjusting the Impedance of the first to the impedance of the second, in order to expand the coverage of the antenna (24).

In this way, the antenna (24) coverage increases and said communication will always be possible when users undergo electrical contact in the same electrical installation (20) wherein the actuator device (200, 200′) is located.

More specifically, said impedance adapter comprises a capacitor, a resistance, a coil, a transformer, a diode, a transistor or a combination thereof.

It is worth mentioning that, optionally, each radio receiver circuit (23) is associated with an unlimited number of radio transmitters (13) by means of a specific combination of at least two simultaneous communication channels with different carrier frequencies which the radio receivers (23) recognise and identify, without taking into account any code included in the carrier signals themselves.

That is to say, the radio signals comprise a combination of at least two carrier signals with different frequencies, which make it possible for the radio receiver (23) to identify each radio transmitter (13). Thus, each radio receiver circuit (23) is associated with the corresponding radio transmitters (13) and identifies them solely and exclusively by the reception of a specific combination of at least two simultaneous communication channels with different carrier frequencies originating from them.

Moreover, the switch-off circuit of the actuator device (200, 200′) is activated when the radio receiver circuit (23) simultaneously receives the combination of at least two simultaneous communication channels, emitted by any of the radio transmitters (13) associated with the radio receiver (23).

On the other hand, in the high-voltage mode, the sensor device (100) may be used to warn individuals when they begin to reduce the safety distance limit between their bodies and the elements subjected to high voltages. This distance limit is calculated by the sensor device (100) by comparing the existing emitted electric field to which the individuals' bodies are exposed at that precise moment, which are detected by means of the detector antenna (1), with alert threshold values programmed in the control stage (7). Said specific threshold values may be modified, within pre-established limits, by individuals through the command interface (8).

Furthermore, in the high-voltage mode it is also possible to interrupt the electrical flow in a high-voltage installation when individuals reduce the safety distance limit with respect to the elements subjected to high voltages by a percentage that may entail an imminent risk of an electric arc. To this end. the sensor device (100) compares the existing emitted electric field to which the individuals' bodies are exposed at that precise moment, which are detected by means of the detector antenna (1), with the communication threshold values that are programmed in the control stage (7).

In this high-voltage mode, the sensor device (100) is carried by individuals on the front part of their clothing, as shown in FIG. 5b, in a shirt pocket (28) or in their hands, when they are at a large distance from elements that may be subjected to high voltages. Therefore, the sensor device (100) may detect specific elements that are electrically active, which makes it possible to prevent potential electric arcs and/or electric shocks.

In a non-limiting manner, when the detector antenna (1) detects the electric field, the electrical signals detected pass into the pre-amplifier (2) and from the latter into the controllable-gain amplifier (3), which amplifies by a gain determined by the control stage (7) on the basis of the mode of use, high-sensitivity or normal-sensitivity, selected by individuals on the command interface (8).

The electrical signals originating from the controllable-gain amplifier (3) pass into the low-pass fitter, which only allows for the passage of electrical signals ranging between 10 Hz and 100 Hz. The electrical signals present in the output of the low-pass filter pass into the first comparator circuit (5), which activates the radio transmitter (13) when the transmission threshold programmed in the control stage (7) is exceeded.

The electrical signals present in the output of the low-pass filter also pass into the second comparator circuit (6), which activates the alarm circuit (105) when the alert threshold programmed in the control stage (7) is exceeded.

Therefore, when the individual undergoes electrical contact, the magnitude of the electric fields detected by the detector antenna (1) will cause the first comparator circuit (5) to activate its output and, in turn, activate the radio transmitter (13), such that it may emit specific wireless radio signals that will reach the actuator device (200, 200′), which will immediately interrupt the electrical flow.

On the other hand, when individuals are at imminent risk of sustaining an electric arc, usually in high-voltage installations, the magnitude of the electric fields to which they are exposed detected by the detector antenna (1) before said arc occurs will cause the first comparator circuit (5) to activate the radio transmitter (13), which will emit specific wireless radio signals that will instantaneously reach the actuator device (200), such that it may act on the automatic high-voltage turn-off switchgear in order to interrupt the electrical flow.

In regard to the actuator device (200, 200′), it is formed by an enveloping insulating housing that presents two configurations, a permanent configuration and a temporary configuration. I.e. a configuration capable of being installed in the electrical installation (20) in a permanent or temporary manner.

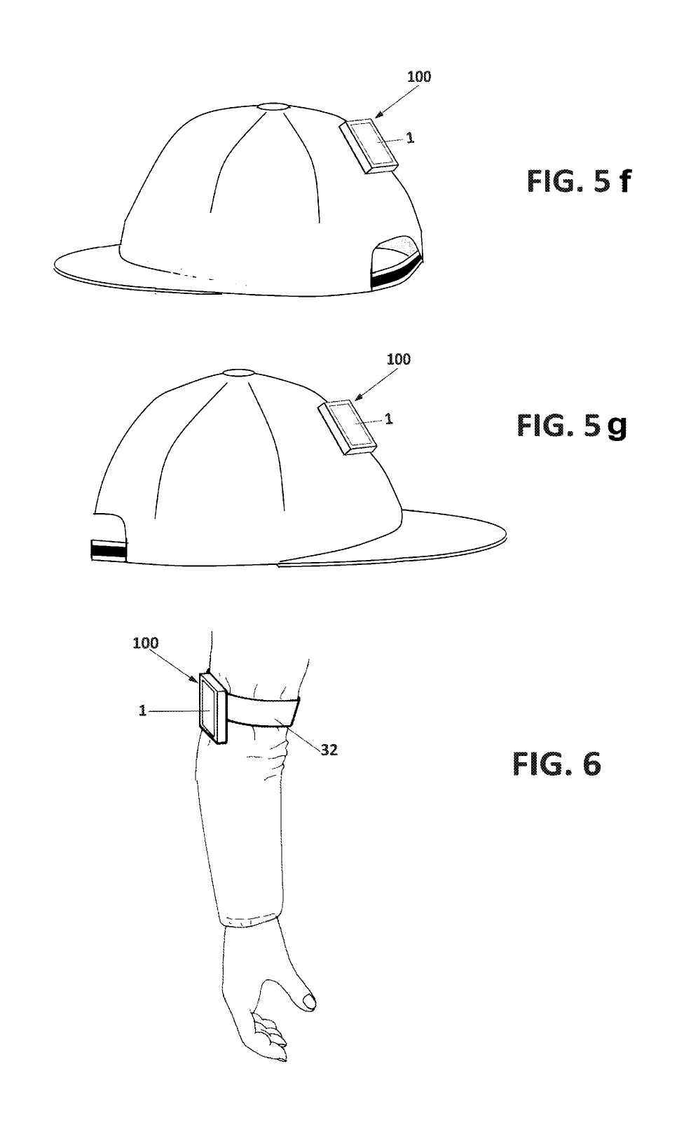

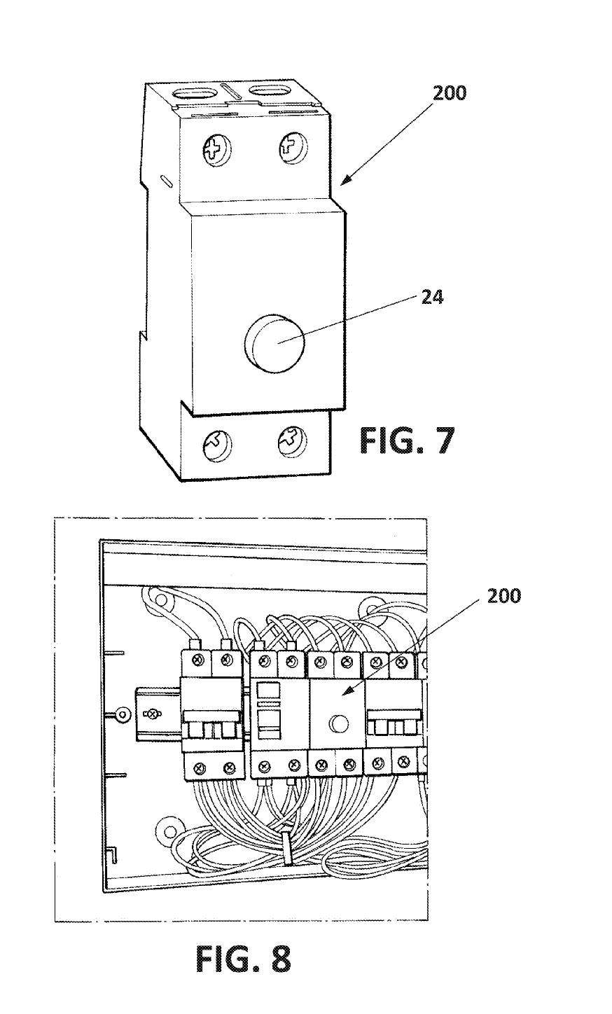

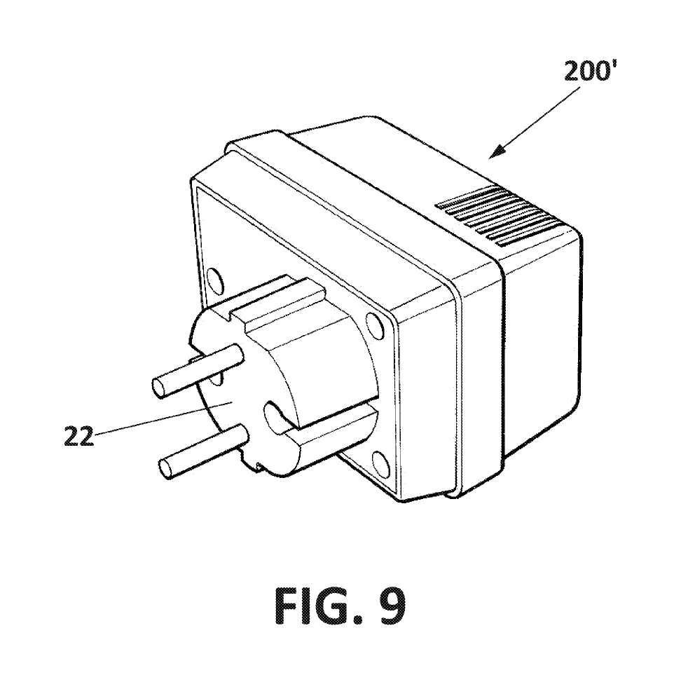

More specifically, as schematically shown in FIG. 7, the actuator device (200) with a permanent configuration has, on one of the outer sides of the enveloping housing, a configuration capable of being connected to a DIN rail of an electrical panel that is a part of the switchgear of the electrical installation (20), and comprises at least one electrical input and one electrical output capable of being connected to the wiring of said electrical panel. As may be seen in FIG. 8, this electrical panel is a conventional electrical panel that all low-voltage electrical installations must have installed, with a plurality of automatic breakers designed to interrupt the flow of electricity in a plurality of electrical installations.

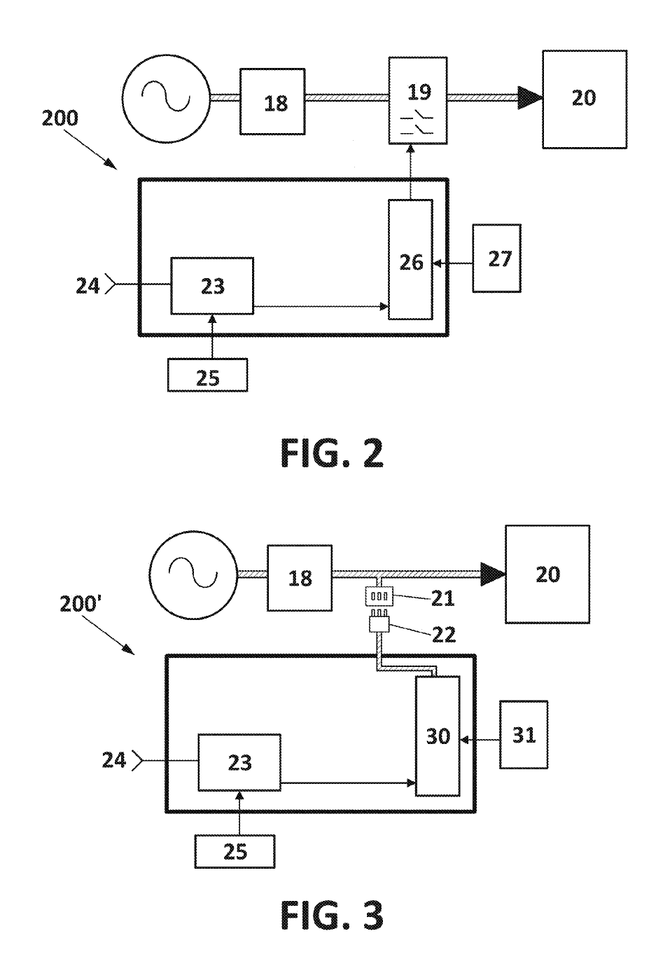

More specifically, the actuator device (200). as shown in FIG. 2. comprises:
a radio receiver circuit (23) that receives the wireless radio signals emitted by the radio transmitter (13) by means of the wireless radio signal receiver antenna (24).
a receiver interface (25) connected to the radio receiver (23), which allows for all types of programming, selection and settings on said wireless signal receiver.
a contactor block (19), essentially formed by an interrupter contactor controlled from the power circuit (26), which interrupts the electrical flow when the contacts are opened.
a power circuit (28) that acts on the contactor block (19) such that it may interrupt the electrical flow in the electrical installation (20).
a power interface (27) connected to the power circuit (26), which makes it possible to test, reset and select the type of reset.

When the radio receiver circuit (23) receives, by means of the receiver antenna (24), the corresponding specific wireless radio signals originating from the radio transmitter (13), it immediately activates the power circuit (26), which acts on the contactor block (19), causing it to instantaneously interrupt the electrical flow into the electrical installation (20).

In regard to the actuator device (200) with a temporary configuration as shown in FIG. 7, it has, on the outer sides of the enveloping housing, a male power supply plug (22) capable of being inserted into an AC power outlet (21) in the electrical installation (20).

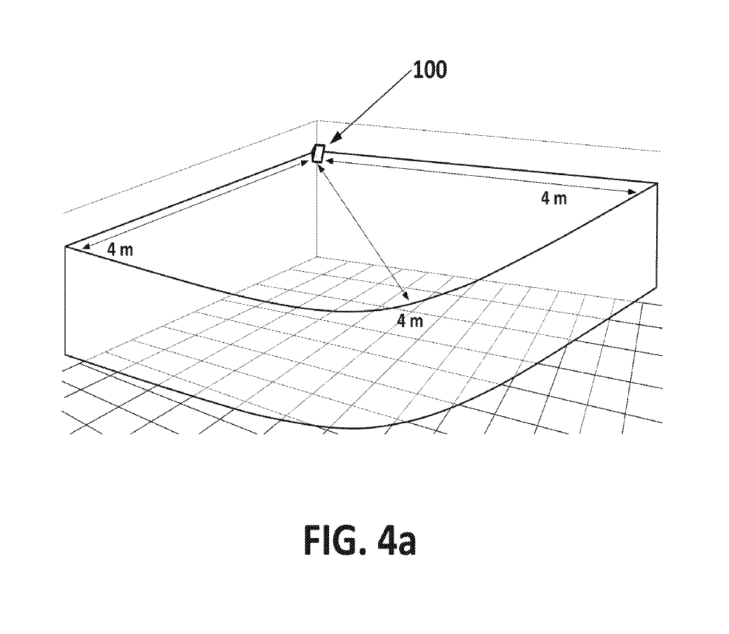

More specifically, as shown in FIG. 3, the actuator device (200′) with a temporary configuration is composed of:
a wireless radio signal receiver circuit (23), which receives the wireless radio signals emitted by the radio transmitter (13) by means of the wireless radio signal receiver antenna (24).
a receiver interface (25) connected to the radio receiver (23), which allows for all types of programming, selection and settings on said wireless signal receiver.
a ground fault and controlled overcurrent circuit (30) capable of simultaneously causing a momentary ground fault and a controlled overcurrent in the electrical installation (20), in order to cause the differential automatic and/or magneto-thermal breakers of the general panel (18) of the switchgear to be triggered and, therefore, interrupt the electrical flow.
a ground fault interface (31) on the ground fault and controlled overcurrent circuit (30), which makes it possible to adjust and check the operation thereof.
a male power supply plug (22) adapted to the enveloping casing of the actuator device (200′) which is designed to be inserted into any AC power outlet (21) in the electrical installation (20).

In a non-limiting manner, when the radio receiver circuit (23) receives, through the receiver antenna (24), the signals originating from the radio transmitter (13), it immediately activates the ground fault and controlled overcurrent circuit (30), such that the differential automatic and magneto-thermal breakers in the general panel (18) of the switchgear may interrupt the electrical flow. The actuator device (200, 200′) is connected by means of the male power supply plug (22), which is connected to an AC power outlet (21) pertaining to said electrical installation (20).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A prevention system and process against electric shocks and/or electric arcs to individuals who are close to an electrical installation that protects the coverage of a safety area for a plurality of individuals through a spatial sensor device or a portable sensor device fastened to the individuals' or operators' clothing, accessories, hats or helmets, which comprises:
at least one actuator device capable of interrupting the electrical flow in the electrical installation when it receives a control signal from a sensor device.
a sensor device, which may operate in a high-sensitivity mode, when the system of the invention is to be adapted to walls, ceilings, tables and similar, detecting the electric field emitted by the body of one or several individuals who come into physical contact with a non-insulated electrically active element in the safety area, without requiring said individuals to have a sensor device adapted to their clothing, accessories, hats or helmets, or may operate in a normal-sensitivity mode, by means of a sensor device carried by individuals that wirelessly detects the electric fields emitted by the individuals' bodies and/or the electrically active elements in the electrical installation, which is wirelessly connected to the actuator device, in order to send a control signal to the actuator device when the individual are at risk of suffering an electric shock and/or sustaining an electric arc, wherein the sensor device comprises:
at least one electric field detector antenna,
at least one amplifier circuit, connected to the detector antenna, formed by a pre-amplifier, which is connected to the detector antenna, and a controllable-gain amplifier, which is connected to the pre-amplifier, the low-pass filter and the control and command circuit,
at least one low-pass filter circuit, connected to the amplifier circuit,
a comparator circuit, connected to the filter circuit,
a control and command circuit, connected to the comparator circuit and the amplifier circuit,
a communication circuit, connected to the comparator circuit, which is capable of sending a control signal to the actuator device, such that it may interrupt the electrical flow,
at least one power supply designed to supply power to these circuits, and
an enveloping insulating housing that includes at least these circuits.

35. The prevention system and process against electric shocks and/or electric arcs to individuals who are close to an electrical installation according to claim 34, wherein the sensor device further comprises an alarm circuit, connected to the comparator circuit and the control and command circuit, which comprises an output stage connected to an acoustic indicator, an optical indicator or a vibrating indicator, wherein the alarm circuit is activated when the value detected by the detector antenna (1) exceeds the specific alert threshold value programmed in the control and command circuit; moreover, the alarm circuit may be used for all alert functions, even when the actuator device is not operative.

36. The prevention system and process against electric shocks and/or electric arcs to individuals who are close to an electrical installation according to claim 34, wherein the communication circuit comprises:
a radio transmitter, which, upon being activated, transmits wireless radio signals to the actuator device in order to interrupt the electrical flow in the electrical installation, and sends a control signal to the actuator device when the value detected by the detector antenna exceeds the transmission threshold value programmed in the control and command circuit,
a transmission interface that makes it possible for individuals to adjust the radio transmitter,
a circuit that generates and increases the amplitude of interrupter radio pulses, which is activated by means of the comparator circuit and is connected to an emitter electrode capable of transmitting said interrupter radio pulse to the actuator device through the individuals' bodies and at least one conductor in the electrical installation.

37. The prevention system and process against electric shocks and/or electric arcs to individuals who are close to an electrical installation according to claim 34, wherein the comparator circuit comprises:
a first comparator circuit connected to the low-pass filter circuit, the control and command circuit, and the radio transmitter, wherein the first comparator circuit activates the communication circuit such that the actuator device may:
interrupt the electrical flow in the electrical installation when the electric field emitted by the individuals' bodies is wirelessly detected by the antenna and exceeds at least one transmission threshold value programmed in the control and command circuit, equivalent to the magnitude of the electric field emitted by individuals' bodies when they come into physical contact with a non-insulated element subjected to an electrical voltage greater than 50 V.
act on the corresponding high-voltage switchgear, so that it may interrupt the electrical flow in the electrical installation when the electric field wirelessly detected by the antenna in the elements subjected to high voltages to which the individuals are exposed exceeds at least one transmission threshold value programmed in the control and command circuit, equivalent to the magnitude of the electric field to which the individuals are exposed when they are at imminent risk of sustaining an electric arc.
a second comparator circuit connected to the low-pass filter circuit, the control and command circuit, and the alarm circuit, wherein the second comparator circuit activates the alarm circuit in order to:
warn individuals about the existence of a risk of electric shock when the electric field emitted by the individuals' bodies wirelessly detected by the antenna exceeds at least one alert threshold programmed in the control and command circuit, equivalent to the electric field emitted by the individuals' bodies when they are in physical contact with a non-insulated element subjected to an electrical voltage ranging between 25 V and 50 V, or when they are in physical contact with an insulated element subjected to an electrical voltage of at least 100 V.
warn individuals that they are approaching an electrically active element under high-voltage conditions and that there is a risk of an electric arc when the electric field wirelessly detected by the antenna in the elements subjected to high voltages to which the individuals are exposed exceeds at least one alert threshold programmed in the control and command circuit.

38. The prevention system and process against electric shocks and/or electric arcs to individuals who are close to an electrical installation according to claim 34, wherein the actuator device comprises:
a radio pulse receiver circuit, which is capable of receiving the wireless radio signals sent by the communication circuit of at least the sensor device, connected to the switch-off circuit, and is capable of recognising the interrupter radio pulse sent through the electrical installation and from the sensor device, activating said switch-off circuit such that it may interrupt the flow in the electrical installation,
a receiver interface connected to the radio receiver circuit, which makes it possible for individuals to perform all types of programming, selection and settings for the reception, of the wireless signals,
a coupling unit between the actuator device and the electrical installation,
a switch-off circuit capable of being connected in the electrical installation,
a safety circuit designed to verify the correct operation of the actuator device,
an impedance adapter, which connects the radio circuit to the wiring of the low-voltage electrical installation, adjusting the impedance of the first to the impedance of the second, in order to expand the coverage of the antenna.
an enveloping insulating housing that includes at least these circuits, and
a power supply designed to supply all the circuits.

39. The prevention system and process against electric shocks and/or electric arcs to individuals who are close to an electrical installation according to claim 34, wherein the switch-off circuit of the electrical installation may comprise:
a contactor block, essentially formed by a contactor that interrupts the electrical flow when the contacts are separated from another, and
a power circuit connected to the contactor block, which causes the latter to separate or connect the contacts,
a coupling unit located on one of the outer sides of the enveloping housing, the configuration whereof is capable of being connected to a DIN rail of a general panel of the switchgear of the electrical installation or an independent electrical panel, which comprises at least one electrical input and one electrical output capable of being connected to the wiring of said low-or high-voltage switchgear, in order to allow the actuator device to interrupt the electrical flow.

40. The prevention system and process against electric shocks and/or electric arcs to individuals who are close to an electrical installation according to claim 34, wherein the switch-off circuit may comprise:
a ground fault and controlled overcurrent circuit, which may cause a ground fault of the electrical flow in the electrical installation and a controlled overcurrent of the same flow in the electrical installation, such that a differential automatic and/or magneto-thermal breaker of the switchgear of said installation may be triggered and interrupt the electrical flow.
a coupling unit located on one of the outer sides of the enveloping housing, which comprises a male power supply plug capable of being inserted into an AC power outlet in the electrical installation.
an interrupter radio pulse receiver connected to the switch-off circuit, which is capable of recognising the interrupter radio pulse sent through the electrical installation and from the sensor device, activating said switch-off circuit such that it may interrupt the flow in the electrical installation.

41. The prevention system and process against electric shocks and/or electric arcs to individuals who are close to an electrical installation according to claim 34, comprising two detector antennae, one of the detector antennae being integrated into one of the outer sides of the enveloping housing of the sensor device, and the other detector antenna being integrated into one of the inner sides of the enveloping housing of the sensor device, the detector antennae further comprising incorporated means designed to expand its detection area by means of an electrical conductor element.

42. The prevention system and process against electric shocks and/or electric arcs to individuals who are close to an electrical installation according to claim 34, wherein the fastening means comprise at least double-sided adhesive tape, Velcro adhesive tape or a clip that may be attached to the individuals' clothing, accessories, hats or helmets; moreover, at least one of the outer sides of the enveloping housing comprises fastening means that comprise an integrable male part on the casing of the enveloping housing of the sensor device which fits together with an integrable female part included in a safety helmet, hat or hood.

43. The prevention system and process against electric shocks and/or electric arcs to individuals who are close to an electrical installation according to claim 34, wherein at least one of the outer sides of the enveloping housing comprises fastening means which comprise openings capable of receiving screws for coupling to a solid structure, such as the wall or the ceiling of a room, or a piece of furniture.

44. The prevention system and process against electric shocks and/or electric arcs to individuals who are close to an electrical installation according to claim 34, comprising the following steps:
positioning an actuator device in the electrical installation,
positioning at least one sensor device, adapting it to walls, ceilings or tables, or to the individuals' clothing, accessories, hats or helmets,
selecting, by means of a command interface included in the sensor device, a mode of use for the sensor device: high- or low-voltage, and high sensitivity, for operation adapted to walls, ceilings or tables, or normal sensitivity, for operation adapted to individuals' clothing, accessories, hats or helmets,
wirelessly detecting, by means of a detector antenna included in the sensor device, an electric near-field in the individuals' own bodies or in the electrically active elements in the electrical installation,
amplifying the signal of the electric near-field by means of an amplifier circuit, comparing said signal of the electric field, by means of a comparator circuit, with the threshold values included in a control and command circuit,
sending a radio signal, by means of a communication circuit, to the actuator device, such that it may prevent electrical flow in the electrical installation when any of the threshold values are exceeded, and
sending an acoustic, visual or vibrating signal, by means of an alarm circuit, to the individuals who are close to the electrical installation when any of the threshold values are exceeded.

45. The prevention system and process against electric shocks and/or electric arcs to individuals who are close to an electrical installation according to claim 34, wherein the radio signals comprise a combination of at least two carrier signals with different frequencies, which make it possible for the radio receiver to identify each radio transmitter located in the same safety area.

46. The prevention system and process against electric shocks and/or electric arcs to individuals who are close to an electrical installation according to claim 34, wherein the controllable-gain amplifier, by means of control from the control and command circuit, is capable of:
operating in the high-sensitivity mode, in order to use the system of the invention for applications wherein the detector device is adapted to walls, ceilings, tables and similar, making it possible to detect the electric field emitted by the body of one or several individuals who come into physical contact with a non-insulated electrically active element in the safety area,
operating in the normal-sensitivity mode, in order to use the system of the invention for applications wherein the detector device is adapted to the individuals' clothing, accessories, hats or helmets, making it possible to wirelessly detect the electric fields emitted by the individuals' bodies and/or the electrically active elements in the electrical installation.

47. The prevention system and process against electric shocks and/or electric arcs to individuals who are close to an electrical installation according to claim 34, wherein the embodiment of the invention comprises establishing alert and transmission thresholds that require the following steps:
establishing, by means of a sensor device, an alert threshold value in the control and command circuit equivalent to the mean value of the electric field that said sensor device individually detects in the bodies of a plurality of individuals when they are in physical contact with a non-insulated electrical element subjected to an electrical voltage ranging between 25 V and 50V,
establishing, by means of a sensor device, an alert threshold value in the control and command circuit equivalent to the mean value of the electric field that said sensor device individually detects in the bodies of a plurality of individuals when they are in physical contact with an insulated electrical element subjected to an electrical voltage of at least 100 V,
establishing, by means of a sensor device, a transmission threshold value in the control and command circuit equivalent to the mean value of the electric field that said sensor device individually detects in the bodies of a plurality of individuals when they are in physical contact with a non-insulated electrical element subjected to an electrical voltage greater than 50 V.
